(19) United States
(12) Patent Application Publication
(10) Pub. No.: US 2020/0039328 A1
(43) Pub. Date: Feb. 6, 2020

(54) DARKENING DEVICE FOR AN ADAS-CAMERA, CONTROL UNIT FOR AN ADAS-CAMERA-SYSTEM, ADAS-CAMERA-SYSTEM AND VEHICLE CONTAINING AN ADAS-CAMERA-SYSTEM

(71) Applicant: ZF Friedrichshfen AG, Friedrichshafen (DE)

(72) Inventor: Viktor Rakoczi, Immenstaad am Bodensee (DE)

(73) Assignee: ZF Friedrichshafen AG, Friedrichshafen (DE)

(21) Appl. No.: 16/528,409

(22) Filed: Jul. 31, 2019

(30) Foreign Application Priority Data
Aug. 6, 2018 (DE) 102018213078.7

(51) Int. Cl. B60J 3/00; G02F 1/29; G01S 3/786; G02F 1/135

(52) U.S. Cl. CPC B60J 3/007; G02F 1/29; B60R 11/04; G02F 1/135; G01S 3/7862

(57) ABSTRACT

This disclosure relates to a dimming element for an ADAS camera comprising a layer that can be placed on a surface of a window that comprises liquid crystal cells that can be actuated individually and absorb light when electricity is applied, in order to dim an image section of the ADAS camera depending on the position of the sun detected by the ADAS camera. A delay layer, located between the layer and the ADAS camera may provide polarized light to the ADAS camera independently of an alignment of the liquid crystal cells in relation to the ADAS camera. The disclosure also relates to a control device for an ADAS camera system, and ADAS camera system, and a vehicle comprising an ADAS camera system.

### RELATED APPLICATIONS

This application claims priority from German Patent Application DE 10 2018 213 078.7, filed Aug. 6, 2018, the entirety of which is hereby incorporated by reference herein.

### TECHNICAL FIELD

The present disclosure relates to a dimming element for an ADAS camera, a control device for an ADAS camera system, an ADAS camera system, and a vehicle comprising an ADAS camera system.

### BACKGROUND

A disadvantage with optical sensors in the field of advanced driver-assistance systems (ADAS) are the multifaceted environmental conditions encountered while in use. Examples include the limited view of the cameras due to soiling, strong glare when the sun is low over the horizon, light beams or internal reflections in the region of the diffused light shade and/or in the lens of the camera itself.

DE 10 2017 118 506 A1 discloses a window system for a passenger compartment of a vehicle. The transparency of a window is reduced by means of electrochromic cells, in order to reduce the intensity of the incident light.

The electrochromic cells described in DE 10 2017 118 506 A1, however, are not suitable for use with cameras in the automotive field. Tungsten trioxide becomes active when an electrical voltage is applied to it, and becomes blue. A tungsten trioxide layer in an ADAS camera system would change the appearance of the color for an image sensor in an ADAS camera. Liquid crystals distributed in polymers and doped with pigment are opaque when no current is applied, and become transparent when subjected to a current. With a power failure in a vehicle, no light would be able to reach the image sensor when an ADAS camera is used with such a liquid crystal. For safety reasons regarding ADAS cameras, this is unacceptable. Another problem with the use of liquid crystals is that they polarize incident light in a linear manner. The surfaces of components of cameras are normally finished such that they reflect or transmit light in nearly all polarization directions. In some cases, however, certain directions may be lacking depending on the orientation of the liquid crystal in relation to the camera, in particular when linear polarized light strikes the camera. Linear polarized light thus results in erroneous measurement results in certain components of cameras.

### SUMMARY

This is a basis for the present disclosure. An object of the present disclosure is to create object-related selective and dynamic dimming against strong glares that occur when the sun is low over the horizon for ADAS cameras, which satisfies the requirements in the automotive field, in particular pertaining to functional safety.

This object is achieved by a dimming element for an ADAS camera as described herein. The object is also achieved by a control device for an ADAS camera system that has the features described herein. The object is also achieved by an ADAS camera system that has the features described herein. The object is furthermore achieved by a vehicle comprising an ADAS camera system according to the present disclosure.

The dimming element according to the present disclosure is intended for an ADAS camera. A surface area of the dimming element may be the same size as the field of vision of the ADAS camera on an inner surface of a windshield or rear window of a vehicle. The dimming element may comprise a layer on the inner surface. The layer may comprise liquid crystals. The liquid crystals can be actuated individually. When a voltage is applied, the liquid crystals absorb light, in order to dim a section of the image recorded by the ADAS camera, depending on the position of the sun detected by the ADAS camera. The dimming element also may comprise a delay layer. The delay layer may be located between the first layer and the ADAS camera, in order to provide light to the ADAS camera independently of an alignment of the liquid crystals in relation to the ADAS camera.

A dimming element substantially corresponds to an aperture. An aperture limits an image field, without affecting the brightness of the image. With the dimming element according to the present disclosure, however, the image brightness can also be affected in a targeted manner. By way of example, the image brightness changes when the liquid crystals are switched on and off at a high frequency. The dimming element may be in the form of a film, for example, which can be glued to the inner surface. The surface area of the dimming element may correspond to the surface area of a surface on the inner surface to which the dimming element is applied. The dimming element is in the form of a trapezoid, for example. In particular, the dimming element may be placed on the inner surface of the windshield such that it is flush with the plane of the surface thereof. As a result, internal reflections between the individual layers are reduced to a minimum.

Advantageously, the surfaces of the inside of the vehicle and the surface of the liquid crystal facing the inside of the windshield or rear window can be protected against reflections by an antireflection layer. The antireflection layer can be configured to the wavelengths of the field of use for the image sensor in the ADAS camera. The layer comprising the liquid crystals is also referred to as a liquid crystal-containing layer or a liquid crystal layer.

An ADAS camera may be a camera in an advanced driver-assistance system (ADAS).

An ADAS comprises at least one environment detection device. The ADAS camera may be an environment detection device. An ADAS may also comprise at least one control device that evaluates information from the environment detection device, and generates control signals based thereon, in order to drive the vehicle in an assisted manner, partially automatically to fully automatically. Fully automatically refers to autonomous driving. The vehicle control signals may be executed by actuators in the form of vehicle control commands, i.e., they participate in the longitudinal and transverse steering.

The ADAS camera may comprise one or more lenses, e.g., three lenses, specifically a wide-angle lens for close range, a lens with a standard focal length for mid-range, and a telephoto lens for long range. The camera also may comprise an image sensor. The images obtained with the ADAS camera are evaluated by a computing unit, e.g., a processor, and in particular, objects are identified, e.g., by means of artificial neural networks. The computing unit may be integrated as a system on the chip in the camera, or is part of an electronic control unit (ECU). The ADAS camera may be configured to record a scenario in the form of a sequence of individual images. Because it is used in the automotive field, the ADAS camera is configured to satisfy the requirements for functional safety according to ISO26262. By way of example, the ADAS camera may satisfy the requirements of the ASIL B-levels. Furthermore, the specifications of the ADAS camera may be such that target functions of the ADAS camera, e.g., recognizing a person as a person, or determining that a vehicle in front of the camera that is moving at a relative speed of zero to the vehicle in which the camera is located, is a moving vehicle, and not a stationary obstruction, can be regarded as sufficiently safe. In addition to aspects of the functional safety, the ADAS camera may also satisfy aspects of the so-called safety of the intended functionality (SOTIF). The viewing field of the ADAS camera may be a two-dimensional field at a distance to the ADAS camera within the object-related volume that can be recorded, i.e., imaged with the ADAS camera such that it is sufficiently in focus. The ADAS camera may be therefore a very special camera, which is designed to fulfill requirements regarding functional safety and SOTIF. An ADAS camera system may be a system that comprises at least one component in addition to an ADAS camera, e.g., a control device. The ADAS camera may be located in the interior of the vehicle when in use. The ADAS camera may particularly be an ADAS front camera, located in the front region of the interior of a vehicle. Alternatively, the ADAS camera is located in the rear area of the interior, with a viewing field directed toward the rear, wherein the dimming element can be placed on the inner surface of the rear window.

A vehicle front window gives the driver of a vehicle a forward view, and protects against wind, weather, and particles in the air flow. The front window is also referred to as a windshield. Correspondingly, the rear window gives the driver of a vehicle a rear view. Windshields and/or rear windows may have a defroster, e.g., in the form of thin wires embedded in the glass of the window, which obscures the view as little as possible.

A liquid crystal (LC), is an anisotropic liquid, and thus a liquid that has different expansion rates in different directions for different polarization directions of incident light. Because of the anisotropy, liquid crystals affect the polarization direction of light waves. A wave is polarized when the deflection of the wave has a specific orientation to the expansion rate of the wave. A wave is polarized linearly when its deflection assumes just one direction, perpendicular to the expansion direction of the wave. With a circular polarized wave, the polarization direction is circular. With a circular polarized wave, all polarization directions occur, alternating over time.

A liquid crystal cell comprises a liquid crystal and means for applying electricity, in order to actuate molecules of the liquid crystal. The electrical voltage can be obtained from an electric or magnetic field. The field can be a direct current field or an alternating current field. Atoms or molecules in liquid crystals are normally rod-shaped or disk-shaped. A liquid crystal cell comprises two plates, for example, wherein the structure of the plate surfaces has a respective primary orientation. By way of example, the liquid crystal cell comprises two plates, each of which has grooves, wherein the grooves in the respective plates are rotated 90° to one another. Both plates are preferably transparent. Both plates may particularly be made of glass. The plates may comprise connecting lines for applying electricity to the plates. By way of example, the outer surfaces of the glass plates may be each coated with an electrode layer that has connecting lines for actuating the liquid crystal cell. The liquid crystal may be located between the glass plates. The liquid crystal may comprise a nematic connection. A nematic connection has the property that components of the nematic connection align themselves in the direction of a field, when the field is applied. This alignment corresponds to a plate capacitor, the dielectric element of which is the liquid crystal cell. In corresponding to the 90° offset of the directions of the grooves in the glass plates, the atoms or molecules of the liquid crystal are aligned helically. This helical structure can also be induced by adding cholesteric compounds. Cholesteric compounds comprise a nematic alignment with a continuously rotating primary orientation. The liquid crystal cell may be located between two polarization filters that are likewise rotated 90° to one another. A transmission axis of the first polarization filter is parallel to the grooves in the first glass plate. A transmission axis of the second polarization filter is parallel to the grooves in the second glass plate. The first polarization filter thus forms a polarizer. The second polarization filter corresponds to an analyzer. If no electricity is applied, incident light is rotated 90° and passes through the liquid crystal. If electricity is applied, the atoms or molecules of the liquid crystal align themselves such that they are perpendicular to the surfaces of the electrodes. Incident light passes through the liquid crystal without rotating. Because the polarization filters are rotated 90° to one another, incident light is absorbed. This example of a liquid crystal cell corresponds to the light control cell disclosed in CH 532 261. One aspect of the present disclosure is that that a dimming element is provided for the automotive field, based on the principles of a liquid crystal in combination with an ADAS camera. The liquid crystal cells are preferably large enough that a single liquid crystal cell, or a composite amounting to, for example, five adjacent liquid cells, corresponds to the size of the sun in the image.

A delay layer or delay plate, also referred to as a wave plate, is an optical component made of an anisotropic material. The polarization direction of the light in which the light wave has a higher expansion rate is referred to as the fast axis, and the direction perpendicular thereto is referred to as the slow axis. Polarized light that is parallel to the fast axis passes through the delay layer more quickly than light that is polarized perpendicular thereto. After passing through the delay layer, two linear polarized components of the light exhibit a phase shift in relation to one another. The delay layer thus alters the polarization and phase of the light passing through it. By way of example, quartz exhibits the properties of a delay layer. The delay layer ensures that light reaches the ADAS camera, independently of an alignment of the liquid crystal cells in relation to the ADAS camera. Without the delay layer, only the light that has been linearly polarized by the liquid crystal cells would reach the ADAS camera, and would result in erroneous measurement results in certain components of the ADAS camera. If the ADAS camera has a polarization filter, and the liquid crystal cells are aligned in relation to the ADAS camera such that the light that has been linear polarized by the liquid crystal cells is absorbed by the polarization filter of the ADAS camera, no light reaches the ADAS camera. This problem is resolved by the delay layer.

Because the ADAS camera is often located close to the windshield or rear window, the field of vision of the ADAS camera where it intersects the inner surface thereof is relatively small. As a result, the dimming element only has to be large enough to cover a relatively small area of the inner surface. The dimming element does not have to cover the entire inner surface of the window. As a result, the dimming element according to the present disclosure can be produced less expensively and more quickly than elements that cover the entire inner surface of a window. It should also be noted that the crystalline structure of liquid crystals is sluggish at low temperatures. This effect becomes more pronounced with larger dimming elements. With the relatively small dimming element according to the present disclosure, this effect is advantageously less pronounced.

One substantial advantage of the present disclosure is that inexpensive cameras can be used in the ADAS system, because they do not need to exhibit the features of high dynamic range (HDR) functionality.

Because the liquid crystal cells can be actuated individually, the dimming element can be actuated selectively and dynamically. Not all of the liquid crystal cells of the dimming element need to be actuated at the same time in order to dim an image portion of the image sensor in the ADAS camera. It is sufficient when just those liquid crystal cells are actuated that dim a portion of the image in the ADAS camera that corresponds to a current position of the sun. In particular, through the dynamic actuation, it is possible to react to a change in the position of the sun appropriately.

Because the liquid crystal cells first absorb light when electricity is applied, light can still reach the ADAS camera in the event of a power failure, thus complying with the functional safety regulations. If instead, light were first able to pass through the liquid crystal cells when electricity is applied, the ADAS camera could no longer record the environment in the case of a power failure.

Further advantages of the diming device according to the present disclosure include the resulting increase in raw images, the increased performance of the image sensor of the ADAS camera, and the improved availability of the image sensor, in particular when subjected to blinding sunlight.

Another substantial advantage of the present disclosure is the capacity to dim surfaces. In particular, when the camera has a large field of vision, specially coated and geometrically shaped diffused light shades are less effective. The liquid crystal layer resolves this problem.

The delay layer is preferably located on the side of the layer facing away from the inner surface of the window. As a result, the delay layer forms a component comprising the layer with liquid crystals and the delay layer located thereon.

The delay layer is preferably a λ/4 delay layer. If a light beam with a linear polarized portion, the polarization direction of which is rotated π/4 in relation to the crystal optical axis, strikes the λ/4 delay layer, circular polarized light is obtained, which then arrives at the ADAS camera. Because all of the polarization directions occur over time in circular polarization, measurement errors no longer occur in the components of the ADAS camera.

In another embodiment, the dimming element can be placed on the inner surface of a window such that the dimming element is functionally connected to a defroster. Alternatively, the dimming element comprises a heating element. The window defroster or the heating element heats the liquid crystal cells. In combination with the defroster or the heating element, the effects of temperature on the liquid crystals are minimized. As a result, the liquid crystals can also be activated at low temperatures.

The liquid crystals of the liquid crystal cells preferably comprise an organic compound. The organic compound comprises molecules made of hydrogen, carbon, and/or oxygen atoms. It is possible to obtain liquid crystals with organic compounds that are not rod-shaped or disk-shaped crystals, in order to improve the optical properties.

The control device according to the present disclosure is intended for an ADAS camera system. The ADAS camera system comprises an ADAS camera and a dimming element according to the present disclosure. The control device comprises a first interface. A position of the sun is obtained on an image sensor of the ADAS camera via the first interface. The control device also may comprise a computing unit. The computing unit determines which liquid crystal cells of the dimming element are to be dimmed by applying electricity in order to dim the position of the sun, depending on the position of the sun on the image sensor, and depending on extrinsic and intrinsic parameters of the ADAS camera. The control device also may comprise a second interface for applying electricity to the liquid crystal cells that are to be dimmed, determined by the computing unit. Depending on the size of the individual liquid crystal cells, a single liquid crystal cell or a composite of adjacent liquid crystal cells are then actuated.

The control device may be an ECU in particular. The control device enables a tracking of the position of the sun on the plane of the liquid crystal cells as it changes, e.g., when a vehicle in which the subject matter of the present disclosure is used, referred to as the ego-vehicle herein, corners. During the cornering of the ego-vehicle, the sun moves in the imaging plane of the ADAS camera. The control device tracks the position of the sun, and selectively and dynamically actuates the liquid crystal cells accordingly.

An interface may be a component between at least two functional units, at which an exchange of logical values, e.g., data or physical values, e.g., electrical signals, takes place, either unidirectionally or bidirectionally. The exchange can be in analog or digital form. By way of example, the interface is a hard-wired interface or a WLAN interface.

A computing unit is an electronic unit that processes input information, preferably in accordance with a specific algorithm, and outputs a result from this processing. Electronic circuits with logical modules are one example of a computing unit. A processor is another example of a computing unit.

Intrinsic parameters of the ADAS camera determine how optical measurements of the image sensor of the ADAS camera and image points, in particular pixel values, of the image sensor are related. By way of example, the focal length of a lens or the pixel density of the image sensor are intrinsic parameters of the ADAS camera. Extrinsic parameters are external parameters of the ADAS camera, e.g., the geometric location of the ADAS camera in space. By way of example, the position of a rear view mirror and the position where the ADAS camera is located on the rear view mirror are extrinsic parameters of the ADAS camera. Knowing the extrinsic and intrinsic parameters of the ADAS camera and the position of the sun in the real world, or on the image sensor, obtained by the computing unit via the first interface, the computing unit creates a one-to-one relationship between liquid crystal cells and pixels of the image sensor. As a result, the control device can actuate the liquid crystal cells in a targeted manner by means of the second interface.

The actuation of the liquid crystal cells, i.e., the application of electricity, advantageously takes place with a modulating frequency that differs from the frequency of the imaging of the ADAS camera. As a result, interference effects, e.g., optical flickering, are substantially avoided.

The ADAS camera system according to the present disclosure comprises an ADAS camera. The ADAS camera system also comprises a diming device according to the present disclosure. The ADAS camera system may also comprise at least one first control device according to the present disclosure, and one second control device according to the present disclosure. The first control device may be configured to actuate a first portion of the liquid crystal cells. The second control device may be configured to actuate a second portion of the liquid crystal cells independently of the first control device. The use of two control devices increases the redundancy of the ADAS camera system. If the first control device fails, for example, because it is no longer supplied with electricity, not all of the liquid crystal cells are subjected to a loss of control. Only the first portion of the liquid crystal cells can no longer be actuated. The second portion of liquid crystal cells can still be actuated with the second control device. As a result, if one control device fails, it is still possible to obtain a dimming effect. Specifically when the liquid crystal cells are arranged in a matrix, the liquid crystal cells are actuated in alternating rows by the first and second control devices.

The dimming element may be located on the ADAS camera. As a result, the subject matter of the present disclosure can also be advantageously used for an ADAS camera that is located outside the interior of the vehicle, e.g., for an ADAS rear view camera that can be mounted on a license plate of the vehicle, or for an ADAS side view camera that can be mounted on a side mirror of the vehicle.

The vehicle according to the present disclosure comprises an ADAS camera system. The ADAS camera may be located on a rear view mirror in the vehicle. The dimming element may be located on a windshield or rear window of the vehicle in the vision field of the ADAS camera. The first and second control devices may be integrated in the ADAS camera or the diming device. The advantages described above are obtained therewith.

### BRIEF DESCRIPTION OF THE DRAWINGS

The present disclosure shall be explained by way of example in the following exemplary embodiments and figures.

FIG. 1 shows an exemplary embodiment of a vehicle according to the present disclosure;

FIG. 2 shows an exemplary embodiment of a dimming element according to the present disclosure;

FIG. 3 shows an exemplary embodiment of an ADAS camera system according to the present disclosure; and

FIG. 4 shows an exemplary embodiment of a liquid crystal cell.

### DETAILED DESCRIPTION

Identical reference symbols in the figures indicate identical or at least similar components. For purposes of clarity, only the reference symbols relevant to the respective figure are given in the individual figures.

FIG. 1 shows a vehicle 1. The vehicle 1 may be a passenger car. The subject matter of the present disclosure can also be used analogously with other land vehicles, e.g., trucks and/or rail vehicles, air vehicles, and/or water vehicles. The vehicle 1 comprises a windshield 2a and a rear window 2b. The windshield 2a and/or the rear window 2b may comprise a window defroster 4. FIG. 1 only shows the defroster 4 for the windshield 2a. The vehicle 1 comprises an interior 6. Passengers can be accommodated in the interior 6. There is a rear view mirror 5 in the interior 6. The vehicle driver is able to observe traffic behind the vehicle through the rear window 2b by means of the rear view mirror 5.

An ADAS camera 31 may be located on the rear view mirror 5, which has a field of vision directed toward the windshield 2a. The ADAS camera 31 may be a mono-camera with just one lens, or a tri-camera with three lenses of different focal lengths and/or apertures, for example. There may be a dimming element 10 on an inner surface 3 of the windshield 2a. The dimming element 10 may be located in the field of vision of the ADAS camera 31, on the inner surface, and may be the same size as the field of vision where it intersects with the windshield. The dimming element 10 may be located on the inner surface 3 of the windshield 2a such that it is flush with the plane thereof. The sun S shines through the windshield 2a onto the ADAS camera 31. Without the dimming element 10 according to the present disclosure, the sun would cause a strong glare in the ADAS camera 31, in particular on an image sensor 32 of the ADAS camera 31, and/or there would be light beams or internal reflections in the region of the diffused light shade and/or in a lens of the ADAS camera 31. These problems caused by the sun S are avoided through selective actuation of individual liquid crystal cells 12 of the dimming element 10.

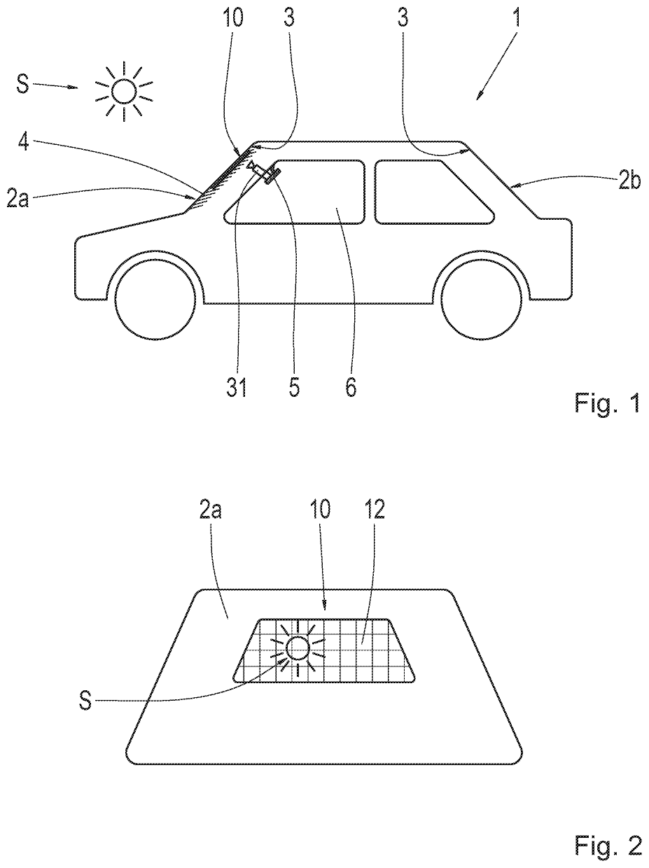

FIG. 2 shows the dimming element 10 applied to the inner surface 3 of the windshield 2a. The dimming element 10 may be in the shape of a trapezoid. The liquid crystal cells 12 may be arranged in rows and columns in a matrix. Through actuation of the dimming element 10 according to the present disclosure, those liquid crystal cells 12 that result in a dimming of the region the size of the sun S in the image are supplied with electricity such that they absorb light. In FIG. 2, a current position of the sun S overlaps four liquid crystal cells 12. These four liquid crystal cells 12 are therefore actuated, and thus dimmed.

Depending on the position of the sun S, or the size of the sun S in the image, more or fewer liquid crystal cells 12 are actuated in order to block out the sun. As the sun S moves across the dimming element 10, e.g., when cornering the vehicle 1, the dimming element 10 is actuated such that the liquid crystal cells 12 that are dimmed changes in accordance with the sun S, such that the sun S is dimmed throughout the cornering.

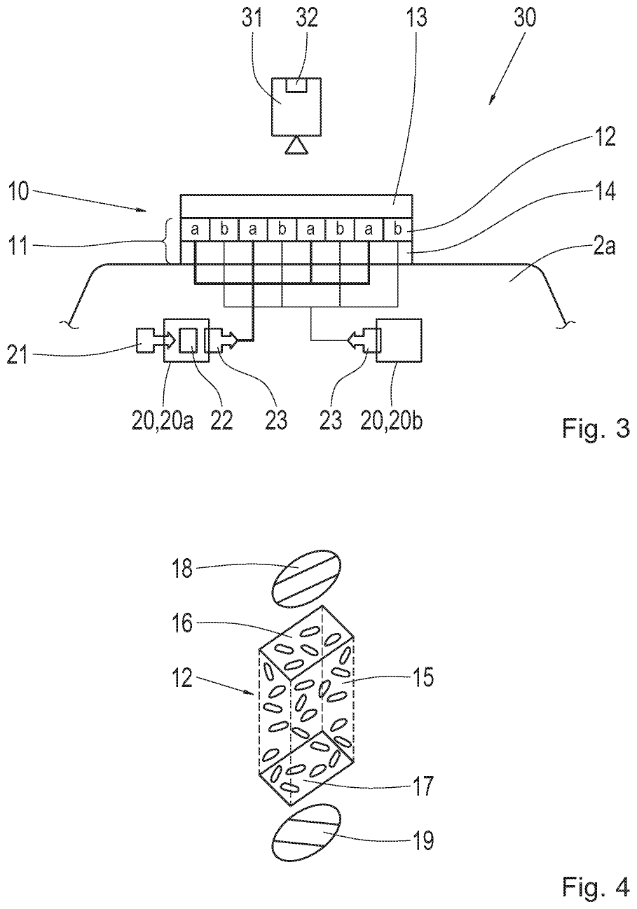

FIG. 3 shows an ADAS camera system 30. The ADAS camera system 30 comprises the ADAS camera 31 and the dimming element 10 according to the present disclosure. The dimming element 10 may comprise a separate heating element 14 with which the dimming element 10 may lie on the inner surface 3 of the windshield 2a. A delay layer 13 may be located between the inner surface 3 of the windshield 2a and the ADAS camera 31. The liquid crystal cells 12 may be located between the heating element 14 and the delay layer 13. The liquid crystal cells 12 may form a layer 11 with the heating element 14 on which the delay layer 13 is located. The liquid crystal cells 12 of the layer 11 may be actuated with a control device 20, i.e., they are supplied in a modulated manner with electricity, such that they are activated and deactivated.

A first control device 20a may control the liquid crystal cells 12 indicated by the letter a. A second control device 20b may control the liquid crystal cells 12 indicated by the letter b. If the first control device 20a malfunctions, the liquid crystal cells a remain transparent. The liquid crystal cells b can still be activated and deactivated with the other control device 20b, and thus dimmed. The same applies if the second control device 20b malfunctions. The first control device 20a and second control device 20b are advantageously located in a space-saving manner inside a housing for the ADAS camera 31.

The control devices 20, 20a, 20b comprise a first interface 21 to the image sensor 32 of the ADAS camera 31. A computing unit 22 of the control device 20, 20a, 20b obtains a position of the sun S on the image sensor 32 of the ADAS camera via the first interface 21, e.g., in the form of data, regarding which pixels of the image sensor 32 image the sun S. The computing unit 22 determines which of the liquid crystal cells 12 of the dimming element 10 are to be dimmed by applying electricity to where the sun S is located on the image sensor 32, depending on the position of the sun S on the image sensor 32 and depending on extrinsic and intrinsic parameters of the ADAS camera 31. The control devices 20, 20a, 20b may also comprise a second interface 23 to the liquid crystal cells 12. Electricity can be applied by means of the second interface 23 to those liquid crystal cells 12 determined by the computing unit 22.

FIG. 4 shows a liquid crystal cell 12 without electricity applied to it. The liquid crystal 15 may be located between a first plate 16 and a second plate 17. The liquid crystal 15 can have a helical arrangement of rod-shaped molecules, for example, that is perpendicular to first plate 16 and second plate 17. The first plate 16 and second plate 17 align the molecules of the liquid crystal 15 through the structure of their surfaces facing the liquid crystal 15. As a result of this alignment, the molecules of the liquid crystal are oriented parallel to the surface of the respective plate 16, 17 in a specific direction. The liquid crystal cells 12 are located between a polarizer 18 and an analyzer 19. When electricity is applied, an electrical field is generated perpendicular to the plates 16, 17, and molecules of the liquid crystal become aligned in the direction of the field, until they are parallel to the field vector as the voltage increases. At this point, the helical structure disappears.

### REFERENCE SYMBOLS

1 vehicle
2a windshield
2b rear window
3 inner surface
4 window defroster
5 rear view mirror
6 interior space
10 dimming element
11 layer
12 liquid crystal cells
13 delay layer
14 heating element
15 liquid crystal
16 first plate
17 second plate
18 polarizer
19 analyzer
20 control device
20a first control device
20b second control device
21 first interface
22 computing unit
23 second interface
30 ADAS camera system
31 ADAS camera
32 image sensor
S sun
a liquid crystal cell
b liquid crystal cell

1. A dimming element for an advanced driver-assistance system (ADAS) camera, wherein a surface area of the dimming element is a same size as a field of vision of the ADAS camera on an inner surface of at least one of a windshield or rear window of a vehicle, the dimming element comprising:
a layer configured to be placed on the inner surface, the layer comprising liquid crystal cells, wherein the liquid crystal cells can be actuated individually, and absorb light when electricity is applied, and configured to dim an image section of the ADAS camera, depending on a position of the sun as detected by the ADAS camera; and
a delay layer, located between the layer and the ADAS camera, configured to provide light to the ADAS camera independently of an orientation of the liquid crystal cells in relation to the ADAS camera.

2. The dimming element according to claim 1, wherein the delay layer is located on a side of the layer facing away from the inner surface.

3. The dimming element according to claim 1, wherein the delay layer is a λ/4 delay layer.

4. The dimming element according to claim 1, wherein the dimming element is placed on the inner surface such that the dimming element is functionally connected to a defroster.

5. The dimming element according to claim 1, wherein the liquid crystals of the liquid crystal cells comprise an organic compound.

6. An advanced driver-assistance system (ADAS) camera system comprising:
an ADAS camera; and
a dimming element, comprising:
a layer comprising liquid crystal cells, the liquid crystal cells configured to be actuated individually, to absorb light when electricity is applied, and to dim an image section of the ADAS camera;
a delay layer located between the layer and the ADAS camera, the delay layer configured to provide light to the ADAS camera independently of an orientation of the liquid crystal cells in relation to the ADAS camera;
a first interface for obtaining a position of the sun on an image sensor of the ADAS camera;
a computing unit configured to determine which liquid crystal cells of the dimming element to dim by applying electricity to the liquid crystal cells at the position of the sun on the image sensor, depending on the position of the sun on the image sensor and depending on extrinsic and intrinsic parameters of the ADAS camera; and
a second interface for applying electricity to the liquid crystal cells determined by the computing unit.

7. The ADAS camera system according to claim 6, further comprising:
wherein the first control device is configured to actuate a first portion of the liquid crystal cells, and the second control device is configured to actuate a second portion of the liquid crystal cells, independently of the first control device.

8. The ADAS camera system according to claim 7, wherein the dimming element is located on the ADAS camera.

9. A vehicle comprising the ADAS camera system according to claim 7, wherein
the ADAS camera is located on a rear view mirror of the vehicle,
the dimming element is located on an inner surface of a windshield of the vehicle in a field of vision of the ADAS camera, and
the first and second control devices are integrated in at least one of the ADAS camera or the dimming element.

10. The dimming element according to claim 1, wherein the dimming element comprises a heating element for heating the liquid crystals.
